(19) United States
(12) Patent Application Publication
(10) Pub. No.: US 2024/0013678 A1
(43) Pub. Date: Jan. 11, 2024

(54) EDUCATION MATERIAL AND MIND GAME

(71) Applicant: Turgut Hologlu, Istanbul (TR)

(72) Inventor: Turgut Hologlu, Istanbul (TR)

(21) Appl. No.: 18/252,623

(22) PCT Filed: Oct. 18, 2021
(86) PCT No.: PCT/TR2021/051059

§ 371 Date: May 11, 2023

(30) Foreign Application Priority Data
Nov. 11, 2020 (TR) 2020/18012

(51) Int. Cl. G09B 23/04

(52) U.S. Cl. CPC G09B 23/04; A63H 33/10

(57) ABSTRACT

This invention is related to the educational material and mind game used to provide individuals with versatile skills and thinking power in the fields of education and play. It consists of the integration pieces (3) of different lengths and geometric shapes (cubic, triangular prismatic, square prismatic, rectangular prismatic, pentagonal prismatic, hexagonal prismatic or other polygonal prismatic shapes and cylindrical) that the integrated piece (2) of different geometric shapes (cubic, triangular prismatic, square prismatic, rectangular prismatic, pentagonal prismatic, hexagonal prismatic or other polygonal prismatic shapes and cylindrical), which is a whole that never separates from the center piece (1) of different geometric shapes (cubic, triangular prismatic, square prismatic, rectangular prismatic, pentagonal prismatic, hexagonal prismatic or other polygonal prismatic shapes, and polyhedral body shapes such as octagonal, dodecahedral, twentieth-sided), integrates and separates; and cavities (4) in suitable geometrical shapes (cubic, triangular prismatic, square prismatic, rectangular prismatic, pentagonal prismatic, hexagonal prismatic or other polygonal prismatic or other polygonal prismatic shapes and cylindrical) into which the adherent part (2) located at the ends of the integration parts (3) can enter.

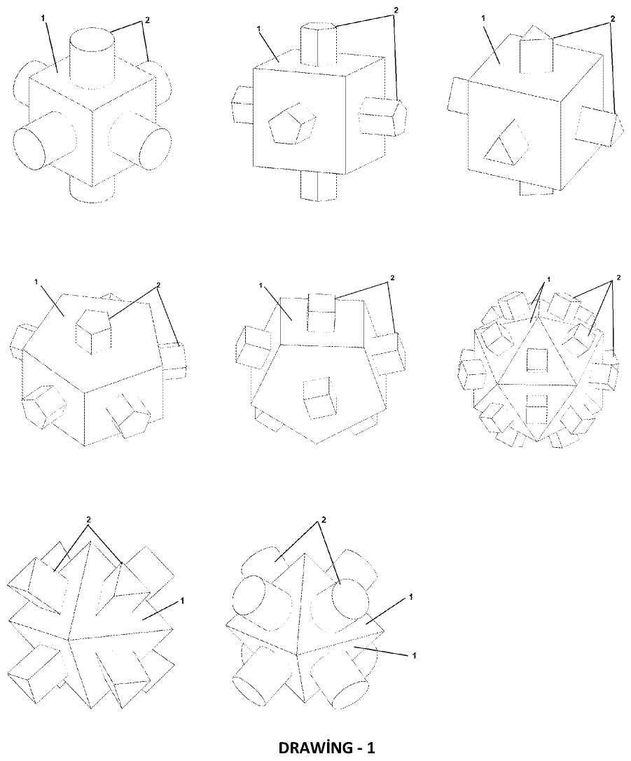

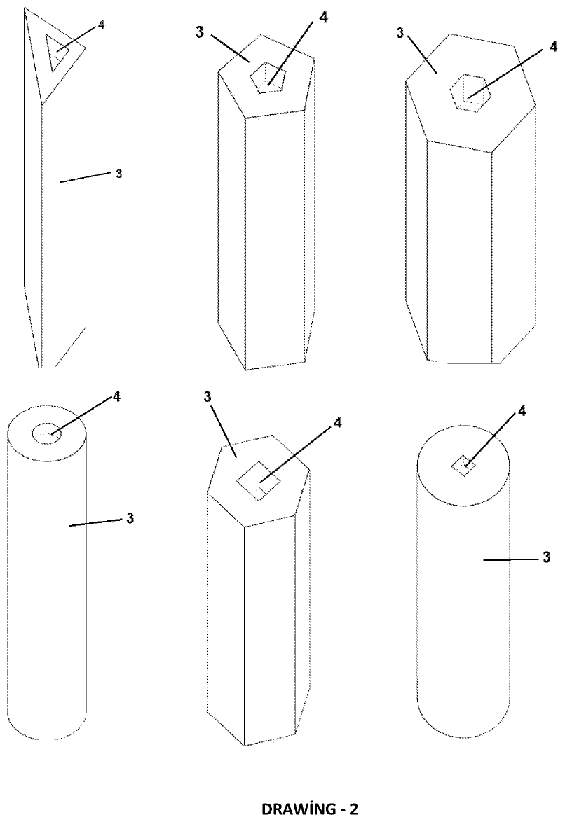

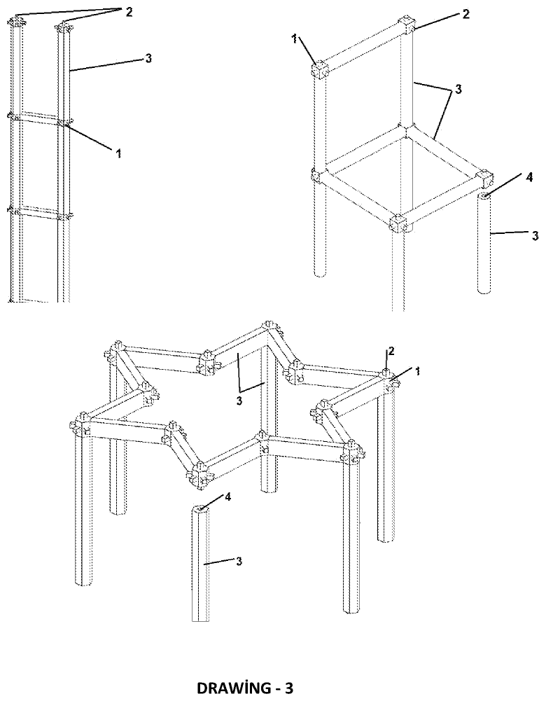

### TECHNICAL AREA

This invention is an educational and intelligence game material that provides the development of education, learning and psychomotor skills and intelligence areas and the development of these areas in interaction, and is applied to provide design/thinking skills to the individuals who are educated.

### TECHNIC'S KNOWN STATUS

In education, there are some material ways in order to develop talents, skills and multi dimensional intelligence areas. Educational material's functions reveals a lot of talents in individuals with learning with living and more intelligence area development. It is important that materials are practical, enjoyable and teachable in their applications.

Known materials' using styles that Teachers have are limited and their using goals are insufficient. Each skill area needs different materials. When viewed from this perspective, because of this situation, prices are high and materials need so much space. Because of existing materials is not functional, it is applicatible only when there is matching and taken from where there was and put there back. This become simple and limited in the ways of talent and intelligence development. Existing educational materials are hardly develop skills that finding similiars and matching in individuals and these are made for specific areas in order to reach their goals. Touching learning and living learning are very little percentage via these materials and learning process not really reach its goal. Pieces that are using in existing educational materials, are suitable for just one specific area so there are lots of new piece and material requirements. That situation, makes production cost higher; this means waste of money and time. Materials that are using in education, although these are touchable, in general these are for two dimensional education. Because of these education materials are limited and restricted, making new products and designing is impossible with these materials. This is a strong disadvantage.

To sum up, there is requirement for overcome all those disadvantages and restrictions, no limit for matching and putting in its place, multifunctional, has a built that are integrated and disintegrated, durable and dynamic, has portable usable parts, can integrate another place that is suitable, its production cost is minimal, its function and design is easy.

### DESCRIPTION OF INVENTION

This invention can overcome the disadvantages and restrictions that mentioned below, and has a function that integration with each pieces and has an integrated form and may disintegrate with each other. It gives the opportunity that pieces' using parts can move and while in this process there will be no deformation and disintegration. Though the number of pieces is few, via these pieces there may build lots of functional tool, and educational materials. This system has functions that is inserted, integrated, and is disintegrated and has durable and dynamic structure, pieces' usable parts may move actively, may transfer and get together in another place. Also this system's production costs are minimal, function variations much, design and using are easy.

The invention provides opportunity to design with lots of tools, equipments and materials with its materials that have the feature of entering/integrating/separating. On surfaces it consists of parts and their features that have a structure that allows the square prism parts to be placed in the square cavities in the middle of the square end surfaces of the square prism parts suitable for the side lengths of the cubic part, where the fixed part adheres to the very middle of the surfaces of the inserting/integrating/separating cubical part on their surfaces. It enables to put/design different tools and equipment with its integrated feature that should insert/separate the square cavity on the upper end surface of the attached piece and the square prism piece, which are whole/fixed to the surfaces of the cubic piece from the educational material and mind game pieces.

The educational material and the mind game consists of the pieces; the integrated piece (2) in different geometrical shapes (cubic, triangular prismatic, square prismatic, rectangular prismatic, pentagonal prismatic, hexagonal prismatic and other polygonal prismatic shapes or cylindrical shapes), which is adhered/whole to the surfaces of the center piece (1) with different geometrical shapes (cubic, triangular prismatic, square prismatic, rectangular prismatic, pentagonal prismatic, hexagonal prismatic or other polygonal prismatic shapes and polyhedral solid shapes such as octagonal, dodecahedral, twenty-sided) and the integration piece (3), which also has different geometrical shapes (cubic, square prismatic, pentagonal prismatic, hexagonal prismatic, and other polygonal prismatic or cylindrical shapes), and the niches (4) on both end surfaces of the integration part (3). The geometric shape of the niches (4) has one of the cubic, square prismatic, pentagonal prismatic, hexagonal prismatic or other polygonal prismatic shapes and cylindrical shapes suitable for the geometric shape of the integrated piece (2), a different structure is created with the feature of the integrated piece (2) to easily enter and integrate into the niche (4), and various tools, equipment and educational materials are designed and produced. When necessary, the integrated piece (2) is easily separated/removed from the niche (4) and combined with another integration piece (3).

With the entering/integrating/separating feature of the integrated piece (2) into the niches (4) on the end surfaces of the integration piece (3), it can be transferred to another part of the uncovered tool and equipment by occurring different tools and equipment with the same parts or by flexibly relocating the parts of the uncovered equipment. Functions that are mentioned provides to occur lots of tools and equipments from less materials. In addition, the ability of the center piece (1) to allow the integrated pieces (2) on each surface to join with different integration pieces (3) by entering the niches (4) from different directions enables the creation of versatile and multidimensional tools, equipment and materials. Because all these processes are made with less tools, there will not waste of materials and cheaps cost of production and it prevent wasting.

Educational materials that are used by teachers provides attention, understanding, matching, learning to students. Via this invention, it is provided that much more improving of students' talent areas. In addition, due to the inadequacy and limited functionality of the available materials, the number of materials needed is reduced and training costs are eliminated thanks to this invention. A large number of useful, realistic tools can be created according to the imagination of the user, with the insert/sp [symbol] litstructure of the educational material and the parts of the mind game. Thanks to its separable structure, these tools can be easily separated by the user when required, and they can be easily recovered when necessary, eliminating the difficulties such as occupying space.

Thanks to the integrating/separating and integrating structure of the parts that make up the invention, different tools are created. Since many tools and equipment can be made with a small number of parts, it enables the user to produce these tools at low cost. In addition, since it allows to produce many different tools, it increases the imagination of the user and improves her/his thinking ability. In addition, since it allows to produce many different tools, it increases the imagination of the user and improves her/his thinking ability. In addition, the invention has a durable and useful structure with its flexible structure. The structural and characteristic features of the invention and all its advantages will be understood more clearly thanks to the drawings given below and the detailed description written with reference to these drawings.

### DESCRIPTION OF THE INVENTION

The invention consists of, center piece (1), integrated piece (2) that is adhered/adjoining/whole/fixed with the surfaces of center piece (1), and the integration piece (3) which there are niches (4) on the end surfaces that are suitable for the geometrical structure of the integrated piece (2).

The invention integrates and separates from each other with the integrate/separate feature of the integrated piece (2) located on the surfaces of the center piece (1) and in the adherent/whole state, and the feature of entering and separating the niche (4) located on both end surfaces of the integration piece (3).

The invention consist of central piece (1) and integrated piece (2) that is whole with center piece (1) (Drawing-1). In the invention adding (Drawing-2), there are views of integration piece's (3) different geometric shapes and different lengths, and views of niches (4) where in the very end of integration piece's (3) surface with different geometric shapes.

It is shown some different examples of tools, equipment and materials (Drawing-3) formed via center piece (1), integrated piece (2) that is whole with center piece (1), and the feature of the integration piece (3) to integrate/separate the niches (4) on the end surfaces of integration piece (3).

### DESCRIPTION OF THE DRAWINGS

The invention will be described with reference to the accompanying drawings so that the features of the invention will be more clearly understood and appreciated, but it is not intended to limit the invention to these particular embodiments. On the contrary, it is intended to cover all alternatives, modifications and equivalents of the invention that may be included within the scope of the invention as defined by the appended claims. This should be understood that the details that showed are description of the preferences that arrangements of invention and shaping the methods and also rules of invention and conceptual features' the most useful and easy to understand description.

This drawings;

Drawing 1—Views of the center piece (1) and the integrated piece (2) in different geometrical shapes

Drawing 2—Views of the integration piece (3) and the niches (4) on its end surfaces in different geometrical shapes

Drawing 3—View of some tools and equipment that are made from pieces.

Drawing that help to understand what the invention is are given with numbers as in addings and with names given below.

### DESCRIPTION OF THE REFERENCES

1. Center piece
2. Integrated piece
3. Integration piece
4. Niche

### DETAILED DESCRIPTION OF THE INVENTION

Invention basically consist of center piece (1), integrated piece (2) that is whole with center piece (1), integration piece (3) and niches (4) where in middle in the end of two sides of integration piece (3). (Drawing-1, Drawing-2, Drawing-3)

In the invention, integration occurs when the integrated part (2), which is adhered to the surfaces of the center part (1), enters the niche (4) located at the end of the integration part (3), and separation occurs when it comes out. Thence, thanks to piece's integration and disintegration form, it occurs variety of tools and equipments. As it seen in Drawing-1, the integrated piece (2), that is whole with center piece (1) never separate each other and these are a whole, and forms a new structure in which it is integrated by entering the niche (4) located at the surfaces at the ends of the integration piece (3). Thus, a structure with high resistance to disintegration and deterioration is formed. As it can be seen in Drawing-1, the integrated piece (2), which is adherent/whole to the center piece (1), is a whole and does not have the feature of separating in any way. Again, as can be seen in Drawing-2, different lengths of tools can be created thanks to the integration pieces (3) of different lengths. As seen in Drawing-3, the integrated piece (2) that enters the niches (4) at both ends of the integration piece (3) provides the formation of different tools, materials, goods and structures. From this point of view, as seen in Drawing-2, the adherent integrated piece (2), which is in the surfaces of the center piece (1), which has the feature of entering and separating into the niches (4) at the ends of the integration piece (3) of different lengths and different geometric shapes, enters into the niches (4) at the ends of the integration piece (3), forming various structures and the center piece (1) and the integration piece (3) can be easily separated from each other. A multidimensional structure can be formed by combining the integrated pieces (2) of different geometric shapes in the whole state, which exist on every surface of the center piece (1) and cannot be separated from each surface, with the niches (4) at the surfaces at the ends of the integration piece (3) of different lengths and different geometrical shapes. The different shapes and dimensions of tools and equipment that this holistic structure indicates are shown in Drawing-3. Again, as can be seen in Drawing-3, different structures, tools, equipments and materials can be formed by entering or separating the niches (4) located at the ends of the integration piece (3) from each surface (six surfaces) together with the non-separable adherent/whole integrated piece (2) on the surfaces of the center piece (1).

To briefly summarize the feature of the product that is the subject of the invention, it consists of the presence of the integrated piece (2) which will allow the pieces to enter and separate from each other, and which is in a cohesive/whole state on every surface of the cubic piece (1) (Drawing-1). A different structure is formed by entering the niches (4) located at the ends of the integration piece (3), of the integrated piece (2) that is adherent/whole with the surfaces of the center piece (1). The integrated piece (2) on each surface of the central piece (1) integrates with different integration pieces (3) from different directions, forming multidimensional structures (Drawing-3).

The invention consists of the integrated pieces (2) in different geometrical shapes that are adhered/whole on each surface of the center piece (1), the integration piece (3) in different geometric shapes and lengths, and the niches (4) of different geometrical shapes suitable for the geometrical structure of the integrated piece (2) located at both ends of the integration piece (3) (Drawing-1, Drawing-2).

1. The invention is related to educational material and mind game, and its feature is; It is characterized by the separation features of any of the integration pieces (3) in different geometric shapes (cubic, triangular prismatic, square prismatic, rectangular prismatic, pentagonal prismatic, hexagonal prismatic or other polygonal prismatic shapes and cylinder shapes) and in different lengths where the niches (4), in geometric shapes suitable for the geometric shape of the integrated piece (2), (cubic, triangular prismatic, square prismatic, rectangular prismatic, pentagonal prismatic, hexagonal prismatic or other polygonal prismatic shapes and cylindrical shapes) that the integrated piece (2) in different geometric shapes (cubic, triangular prismatic, square prismatic, rectangular prismatic, pentagonal prismatic, hexagonal prismatic or other polygonal prismatic shapes and in cylindrical shapes) which is a whole with and is located on each surface of the center piece (1) which ensures the formation of a holistic structure and is in different geometric shapes (cubic, triangular prismatic, square prismatic, rectangular prismatic, pentagonal prismatic, hexagonal prismatic or other polygonal prismatic shapes and polyhedral body shapes such as octagonal, dodecahedral, twenty-sided) enters/integrates/joins are located.
It is characterized by the separation features of any of the integration pieces (3) where the niche (4) is located and this niche is that the integrated piece (2) enters which is a whole with and is located in the middle of each surface of the cubic piece (1) which ensures the formation of a holistic structure.

2. It is the educational material and mind game mentioned in claim 1, and its feature is; It is characterized by the fact that the integrated piece (2), which is located on each surface of the center piece (1) as a whole, integrates and separates into the niches (4) at the ends of the integration pieces (3) of different lengths and geometric shapes, forming different structures, tools and equipment.

3. It is the educational material and mind game mentioned in claim 1, and its feature is; It is characterized by the fact that the integrated piece (2) of different geometric shapes, which is a whole with the cubic piece (1) and located in the middle of each surface of it, integrates and separates into the niches (4) located at the two ends of the integration part (3) of different lengths and different geometrical shapes.

4. It is the educational material and intelligence game mentioned in claim 1, and its feature is; It is characterized by the fact that the niches (4) of different geometrical shapes on both end surfaces of the integration piece (3) of different lengths and different geometrical shapes are suitable for the geometrical structure of the integrated piece (2) of different geometrical shapes.

5. It is the educational material and intelligence game mentioned in claim 1, and its feature is; It is characterized by the fact that the niches (4) where the integrated pieces (2) that are located on all surfaces of the center piece (1) and form a whole with the center piece (1) enter, meet the integration piece (3) and form a unity with the center piece (1) and form tools, equipment and materials in various structures.

6. It is the educational material and intelligence game mentioned in claim 1, and its feature is; It is characterized by the fact that the integrated piece (2), in which it is a whole with the center piece (1), can easily be separated from the niches (4) on the surfaces of the integration pieces (3) into which it has entered, and it is moved to the different integration pieces (3) and integrates by entering their niches (4), thus, in many ways, creating multidimensional tools, equipment and materials by bringing the integration pieces (3) together from different directions from many angles and forming a whole.

7. It is the educational material and intelligence game mentioned in claim 1, and its feature is; It is characterized by the fact that the side lengths and area of the surfaces of the center piece (1) are in harmony with the side lengths and area of the square surfaces at the ends of the integration piece (3) and are of the same size.

8. It is the educational material and intelligence game mentioned in claim 1, and its feature is; It is characterized by the fact that it contains niches (4) of different geometric shapes on the surfaces at the ends where the center piece (1) with different geometric shapes is easily separated from the integration piece (3) with different geometric shapes and moved to different places, where it enters and leaves the integration pieces (3) with different geometric shapes.

9. It is the educational material and intelligence game mentioned in claim 1, and its feature is; It is characterized by the fact that the integration parts (3) are combined with the different surfaces of the central part (1), making multidimensional connections and creating different dimensional tools, equipment and materials.
